(19) United States
(12) Patent Application Publication
(10) Pub. No.: US 2026/0127915 A1
(43) Pub. Date: May 7, 2026

(54) SLEEP STATE CONSUMPTION ESTIMATION FOR VEHICLES

(71) Applicant: Rivian IP Holdings, LLC, Irvine, CA (US)

(72) Inventors: Sanjeewa Keven SUGATAPALA, Long Beach, CA (US); Kyle LOBO, Westchester, CA (US); Baojin WANG, San Marcos, CA (US); Long Phi HUYNH, Brea, CA (US); Ajay KUMAR, Phoenix, AZ (US)

(21) Appl. No.: 19/174,778

(22) Filed: Apr. 9, 2025

Related U.S. Application Data
(60) Provisional application No. 63/717,751, filed on Nov. 7, 2024.

(51) Int. Cl. G07C 5/00; B60L 58/12; G06F 1/3296

(52) U.S. Cl. CPC G07C 5/004; B60L 58/12; G06F 1/3296; B60L 2250/16; B60L 2260/26

(57) ABSTRACT

Sleep state power consumption estimation for vehicles is provided. An electric vehicle can include an electronic control unit (ECU). The ECU can enter a sleep state responsive to the electric vehicle entering a sleep mode and enter a run state from the sleep state responsive to the electric vehicle exiting the sleep mode. The ECU can determine, based on a range loss estimation corresponding to an estimated power consumption during the sleep mode, a remaining rage estimation of the vehicle. In some implementations, the electric vehicle includes sensors, and the ECU can obtain sensor data indicating a power consumption measurement during the sleep mode of the electric vehicle, from which the remaining range estimation can be determined. In other implementations, the ECU can determine the remaining range estimation without active hardware monitoring based on a predetermined sleep state power consumption rate and a duration of the sleep mode.

### CROSS-REFERENCE TO RELATED APPLICATION(S)

This application claims the benefit of U.S. Provisional Application Ser. No. 63/717,751, entitled “SLEEP STATE CONSUMPTION ESTIMATION FOR VEHICLES,” and filed on Nov. 7, 2024, the disclosure of which is expressly incorporated by reference herein in its entirety.

### INTRODUCTION

Vehicles are often provided with sensors for sensing aspects of the vehicle's operation and/or condition during operation of the vehicle. These sensors are typically disabled or off when the vehicle is not in operation.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 2 depicts a view of example of a power system architecture that may be included in the vehicle of FIGS. 1A and 1B in accordance with one or more implementations.

FIG. 3 is a flow chart of illustrative operations that may be performed for sensor-based sleep state consumption estimation for vehicles in accordance with one or more implementations.

FIG. 4 is a flow chart of illustrative operations that may be performed for self-learning sleep state consumption estimation for vehicles in accordance with one or more implementations.

FIG. 5 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. Structures and components are shown in block diagram form in order to avoid obscuring the concepts of the subject technology.

Vehicles are often left parked in parking lots, parking garages, and along streets, sometimes for hours or days at a time. Parked vehicles are typically left in an off or sleep state in which most, if not all, of the mechanical or electrical systems of the vehicle are also off or in a standby state. This can reduce the power consumed while the vehicle is in the sleep or off state, which can be particularly beneficial for electric vehicles that are propelled by electrical power. However, it can also be advantageous to be able to monitor various systems and/or characteristics of the vehicle, even when the vehicle is in an off or sleep state. As one illustrative example, it can be beneficial to monitor a battery of a vehicle to detect power consumption continuously while in sleep mode that could, if not monitored, cause inaccurate remaining range estimations upon wake-up, which may contribute to user inconvenience and range anxiety.

The subject technology addresses challenges involving the lack of an active system to monitor power consumption and estimate range loss during vehicle sleep mode. Embodiments of the subject technology provide for integrating a hardware sensor (e.g., a power sensor integrated circuit) into the vehicle's architecture to monitor power consumption continuously while in sleep mode. This sensor can measure the power consumption during the vehicle sleep mode, enhancing the accuracy of range estimates when the vehicle is in a wake state. Aspects of the subject technology can provide monitoring (e.g., for power consumption) in a vehicle (e.g., in a vehicle battery or battery pack), while the vehicle is in a sleep mode. The monitoring may be performed by switching one or more processing cores of an electrical control unit (ECU) of the vehicle to a run or wake state to obtain and analyze sensor data.

Embodiments of the subject technology also provide for setting a predetermined sleep state power consumption rate (e.g., 10 watts per hour) from a high-voltage (HV) battery pack upon vehicle sleep initiation without active hardware monitoring. During this sleep state period, all processing cores (including all electronic control units (ECUs)) may become inactive, resulting in a lack of hardware not tracking range loss. One or more processing cores of an ECU in a run state (or wake state) may calculate a range loss based on the predetermined sleep state power consumption rate for the entire sleep duration. Upon transitioning into the wake state, the estimated range loss can be applied, providing a worst-case (or conservative) remaining range estimation to a user of the vehicle. Once the vehicle resumes driving (or an active drive state is detected), the one or more processing cores in the run state can recalibrate the state of charge of the HV battery pack to refine the actual sleep state consumption rate. This recalibrated sleep state consumption rate, updated from the predetermined sleep state consumption rate to a more accurate value, can be applied each time the vehicle enters the sleep mode, enabling self-calibration of range loss estimations during sleep mode without active hardware monitoring.

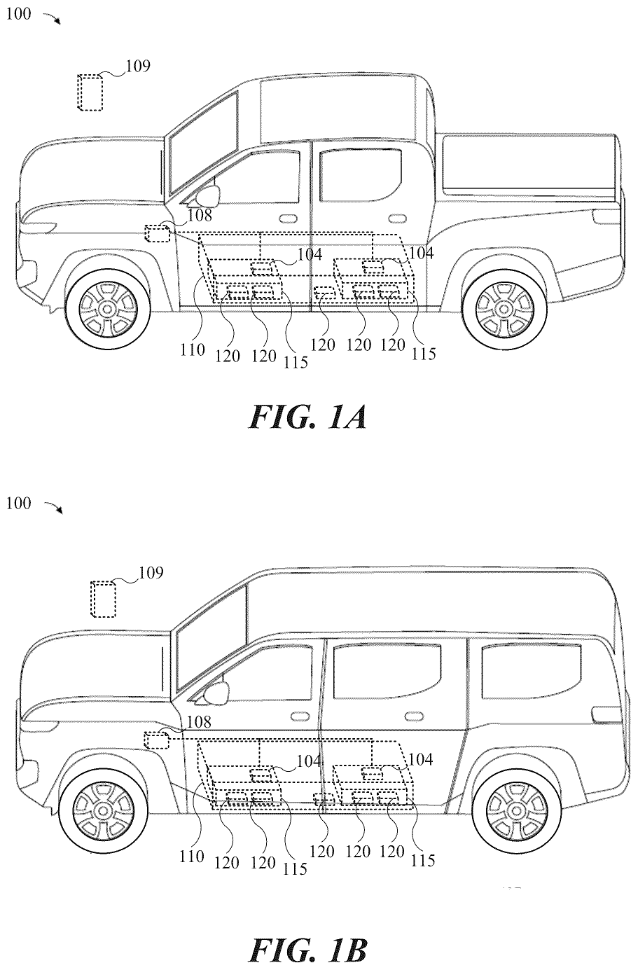

FIG. 1A is a diagram illustrating an example implementation of an apparatus as described herein. In the example of FIG. 1A, the apparatus is a moveable apparatus implemented as a vehicle 100. The vehicle 100 may be implemented as an electric vehicle and may include one or more batteries 110 for powering the vehicle and/or one or more systems and/or components of the vehicle. As shown, the battery pack 110 may include one or more battery cells 120. As shown in FIG. 1, the battery pack 110 may also, or alternatively, include one or more battery cells 120 mounted directly in the battery pack 110 (e.g., in a cell-to-pack configuration). The battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations. For example, the battery cell 120 can be included in a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

In the example of FIG. 1A, the vehicle 100 is implemented as a truck (e.g., a pickup truck) having one or more batteries 110 (e.g., a battery pack in which multiple, such as hundreds or thousands of battery cells are disposed), and processing circuitry 108 (e.g., including one or more electronic control units (ECUs) including one or more processors, memory, and/or communications circuitry). The example of FIG. 1A, in which the vehicle 100 is implemented as a pickup truck having a truck bed, is merely illustrative. For example, FIG. 1B illustrates another implementation in which the vehicle 100 including the battery pack 110, the sensors 104 and the processing circuitry 108 is implemented as a sport utility vehicle (SUV), such as an electric sport utility vehicle.

As shown, the vehicle 100 may include one or more sensors 104. In the example of FIG. 1A, the sensor 104 is disposed within the battery pack 110 (e.g., within a battery pack housing in which the battery cells are also disposed). In various examples, the sensor 104 may include a pressure sensor, a temperature sensor, a pressure sensor, and/or other sensors or combinations of sensors. In one illustrative example that is discussed herein, the sensor 104 is a power sensor. Power sensors in electric vehicles can assess the state of charge (SoC) and overall health of the battery pack 110, providing beneficial data for range estimation and energy management. These power sensors can monitor the current flowing into and out of the battery pack 110, measuring voltage, current, and temperature to estimate energy usage and available capacity. The sensor 104 can employ coulomb counting, which can track the charge entering and exiting the battery pack 110, and advanced algorithms to account for the effects of temperature, aging, and varying load conditions on battery capacity. By measuring this power consumption data, the sensor 104 can allow the processing circuitry 108 to accurately report remaining range, power usage trends, and anticipated charge levels, facilitating power management and optimizing the efficiency of the vehicle 100. The sensor 104 can function as a power sensor having a single channel or multi-channel power monitor with an accumulator and a 32V full-scale range.

Embodiments of the subject technology provide for addressing challenges facing electric vehicles that enter a sleep mode after being parked. The vehicle 100 can enter a low-consumption state rather than transitioning into a fully powered off state. In this low-consumption state, high-voltage systems may be deactivated, while certain low-voltage systems, such as alarm functions, may still draw power from the battery pack 110. Consequently, there is still some power consumption from the high-voltage battery pack. In this regard, the primary challenge is determining the range consumed while the vehicle remains in sleep mode. As the vehicle 100 enters this sleep mode, all main monitoring electronics are set to an inactive state, ceasing active power consumption tracking during the sleep mode.

In order to detect such range loss during a sleep mode of the vehicle 100, sensing of the power consumption during the sleep mode using the processing circuitry 108 and the sensor 104 may be performed. For example, using the sensor 104 can enable continuous monitoring through coulomb counting, capturing and storing range loss estimations during the sleep mode of the vehicle 100. When a range loss estimation is determined by the processing circuitry 108, the processing circuitry 108 may transmit an alert (e.g., over a wired or wireless connection) to another device 109 (e.g., a portable device) external to the vehicle, such as a smartphone or other electronic device of a user of the vehicle 100.

The subject technology addresses challenges in range estimation through software (without active hardware monitoring) using a predetermined sleep state power consumption rate to model the range loss during vehicle sleep, where remaining range estimations and range loss estimations can occur after the vehicle 100 exits sleep mode. Any update to a remaining range estimation can be delayed to evaluate the state of charge of the battery pack 110 once driving resumes and assess the actual remaining range of the vehicle 100. For example, the remaining range estimation can be updated after the vehicle 100 begins to drive rather than immediately after transitioning into a wake state (or active state).

Providing the end user with an accurate estimation of range loss while the vehicle is parked is beneficial, enabling users to plan effectively for upcoming trips. This information can assist with customer-facing features, such as planning the next charge interval, determining a remaining range estimation for a planned trip, and deciding whether charging is beneficial prior to a trip.

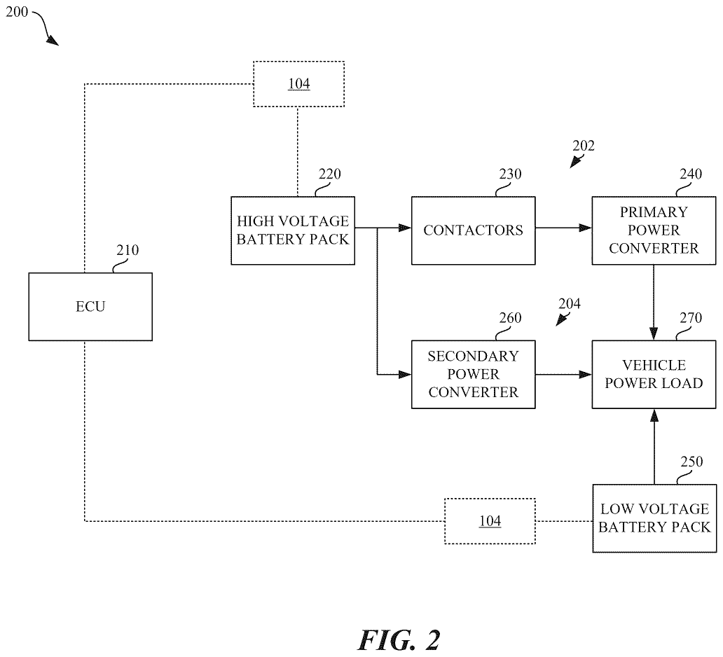

FIG. 2 depicts a view of example of a power system architecture 200 that may be included in the vehicle 100 of FIGS. 1A and 1B. In the power system architecture 200, a high voltage battery pack 220 serves as the primary energy source, with power flowing through two distinct paths, one designated as a first power signal path 202 and the other as a second power signal path 204.

On the first power signal path 202, the high voltage battery pack 220 is connected to a set of contactors 230, which may function as electrically controlled switches for routing power to downstream components. The contactors 230 can enable or disable the power flow to a primary power converter 240, which may be implemented as a main DC-DC converter. The primary power converter 240 can receive power from the high voltage battery pack 220 via the contactors 230 and steps down the voltage to a level suitable for the vehicle power load 270. The power delivered through this pathway may primarily sustain the operational requirements of the vehicle 100 during active driving or high-demand modes.

In parallel, the second power signal path 204 provides an alternate energy route. In this path, the high voltage battery pack 220 is directly connected to a secondary power converter 260, which serves as a supplementary DC-DC converter. When the vehicle 100 enters sleep mode, the contactors 230 and the primary power converter 240 are powered off. In this state, power flows from the secondary power converter 260, supplemented by periodic bursts from the low voltage battery pack 250. During low-power states, such as when the vehicle 100 is in a sleep mode, the secondary power converter 260 supplies energy to the vehicle power load 270 to maintain certain functions with minimal power consumption. The low voltage battery pack 250 can supplement the energy provided by the secondary power converter 260 in periodic bursts, extending operational longevity in the sleep mode. The low voltage battery pack 250 includes a 12V battery.

As shown, an ECU 210 may include one or more processing cores. The one or more processing cores in the ECU 210 may be transitionable between multiple available power states or modes. For example, the multiple available power states may include a run state in which all aspects of the processing core are available and active, an idle state in which, for example, a CPU clock is disabled, Direct Memory Interface and/or Program Memory Interface (DMI/PMI) memories are accessible, and peripherals remain active, a sleep state in which peripheral clocks are gated and the CPU is disabled, and a standby (e.g. lowest power) state in which the main domain is powered off (e.g., and standby RAM may be active).

This sleep state monitoring can be achieved by adding sensors to the vehicle 100 that remain active in low power modes of the vehicle 100. The sensors 104 are integrated at specific monitoring points to measure power draw and track current levels. The ECU 210 may host software to obtain and process sensor data (e.g., power consumption data) and estimate the range loss during a sleep state based on the sensor data. The ECU 210 may be transitioned between multiple power states to allow monitoring of the vehicle 100 (e.g., using sensor(s) 104) when the vehicle 100 is in the sleep mode.

Traditional OEM configurations use low-voltage modules and controllers manufactured by various third parties, limiting the capability to aggregate all consumption data across both high and low voltage sources comprehensively. The implementation illustrated in FIG. 2 provides an all-in-one hardware solution, which includes the sensor(s) 104 for precise tracking of the power draw (e.g., current) during sleep mode and range loss estimation, rather than relying on the secondary power converter 260, which, in one or more other implementations, may not perform active range loss monitoring in the power system architecture 200. As such, this implementation can address these limitations by providing continuous, integrated monitoring of the total consumption by the vehicle 100 during sleep states.

In accordance with aspects of the disclosure, innovative operation of existing vehicle hardware can be used to achieve monitoring (e.g., range loss detection) in vehicle sleep. The sleep state monitoring disclosed herein may be agnostic to the hardware and/or sensors that are performing the monitoring (e.g., the sensing for range loss estimations) and can be extended to multiple programs and/or product lines without additional hardware cost. The sleep state monitoring disclosed herein may be applied to existing vehicles via an over-the-air (OTA) update without requiring physical servicing of vehicles.

The sensor 104 may be connected in series with existing vehicle circuitry to capture load accurately. A sensor 104 can be positioned at the output of the secondary power converter 260 and low voltage battery pack 250, providing continuous current monitoring during sleep mode. One set of sensors monitors the output of the secondary power converter 260, capturing real-time data on energy flow through the second power signal path 204 during sleep mode. For example, a first sensor 104 may be connected in series between the output of the secondary power converter 260 and the vehicle power load 270 along the second power signal path 204 for monitoring the power draw from the secondary voltage source during sleep mode. Another set of sensors is positioned to monitor the output of the low voltage battery pack 250, providing information on supplemental energy contributions during sleep mode. For example, a second sensor 104 may be connected in series between the output of the low voltage battery pack 250 and the vehicle power load 270 for monitoring the power draw from the low voltage source during sleep mode.

The sensor 104 also can be positioned at the input of the secondary power converter 260 instead of at the output of the secondary power converter 260, allowing coulomb counting to account for efficiency variations observable at the output of the secondary power converter 260. This placement can enable enhanced characterization of the battery pack 110 and provide a higher resolution for range loss and range estimates based on real-time sensor data collection.

The ECU 210 can receive, store and/or process the total consumption data of the vehicle 100 during sleep mode. In one or more implementations, sensor data collection, particularly from the sensor 104, can be conducted while the vehicle 100 is in sleep mode. The sensor data collection from the sensor 104 can be conducted while the vehicle 100 is operating in an active driving state. Data collected from the sensor 104 may be consistently processed by the ECU 210, with a specific application for calculating sleep current estimates and monitoring sleep charge dissipation.

The use of the sensor 104 can provide for initial estimates to be performed based on power draw activity observed during sleep mode at the measurement points in the power system architecture 200. The use of the sensor 104 can enhance the resolution of the range loss estimations by serving as a more granular baseline that builds upon a predetermined range loss estimation serving as a coarse baseline, contributing to a calibration process that improves overall accuracy of the range loss estimations. The ECU 210 may provide for transmission the sensor data, or at least a portion thereof, to a cloud-based system (not shown), which can incorporate geolocation data for dynamic range calculations. For example, when moving the vehicle 100 from location A to location B, sensor data collected at location B can be utilized to inform the user of the vehicle 100 about expected range and charging needs. The data collected can be sent to the cloud-based system, contributing to a comprehensive data pool that facilitates more robust estimates for vehicle performance and range calculations.

The sleep mode power consumption can be sampled at defined intervals by the sensor 104. The ECU 210, using the sensor 104, may first establish an average current over longer intervals, such as 30 or 50 minutes, providing a baseline range estimate. In configurations where coulomb counting hardware is used, measurements occur with a higher resolution, capturing electrical current variations at intervals as short as one second or 30 seconds. This can facilitate finer-grained monitoring, whereby each 30-second increment can be calculated and accumulated to track real-time electrical current fluctuations, such as those caused by temperature changes. For example, if the vehicle temperature rises at 1 PM compared to 10 PM, coulomb counting may continuously capture these effects, sampling every 30 seconds to adjust electrical current calculations dynamically. With this higher sampling frequency, overall error in range estimation can be minimized.

The vehicle 100 may incorporate a security feature that enables the activation of a camera system, allowing video feeds to be accessed via a mobile device. A user of the vehicle 100 can request video feeds at random intervals, introducing variability in data collection. The use of the sensor 104 allows for continuous monitoring of energy consumption. For example, if a user of the vehicle 100 watches a video feed for several minutes during which the vehicle 100 is in a sleep mode, the system can capture data points indicating fluctuations in current draw during vehicle sleep. This results in a reduction of overall range loss estimation errors due to the capability of obtaining granular data with the sensor 104.

The ECU 210 may set a predetermined sleep state power consumption rate (e.g., 10 watts per hour) from the high voltage battery pack 220 upon vehicle sleep initiation. Upon entering sleep mode, the ECU 210 can apply the predetermined sleep state power consumption rate and calculate a total range loss during the sleep mode based on a sleep mode duration, computed as t_{wake}−t0, where t₀ is the time at which the vehicle 100 enters the sleep mode and t_{wake} is the time at which the vehicle 100 exits the sleep mode and enters a wake state. The range loss estimation can be calculated by selecting a conservative sleep state power consumption rate (e.g., in a range of 10 watts per hour (wph) to 30 wph). When the vehicle 100 transitions from the sleep mode to the wake state, the ECU 210 can calculate the actual range loss based on the sleep mode duration and the predetermined sleep state power consumption rate to provide a user of the vehicle 100 with a remaining range estimation. The remaining range estimation may be a lower-than-actual estimate, resulting in the user having a surplus in the remaining range.

As driving resumes, the ECU 210 can recalibrate the state of charge of the high voltage battery pack 220 by updating the remaining range estimation based on real-time conditions and generating an updated range loss estimation. With continuous monitoring capabilities integrated into the vehicle's architecture, including software-defined functionalities, the self-learning implementation can update sleep state power consumption estimations iteratively. These iterative updates may allow the vehicle 100 to improve its own understanding of power consumption while in the sleep mode, which reduces complexity and costs associated with additional hardware while achieving more accurate remaining range predictions.

A feedback mechanism can facilitate the calculation of the updated range loss estimation that accounts for factors such as battery degradation, environmental conditions, and other external variables influencing battery performance over time. As the battery ages, the rate of range loss may vary, with temperature acting as an additional influential factor. For example, in high-temperature geographical regions, electronics may exhibit higher leakage during a sleep state than in geographical regions with temperate climates, leading to regional variance in energy consumption.

The feedback mechanism may continuously update the range loss estimation by collecting data on battery cell voltages, voltage sag, and battery module balancing during each drive cycle. The battery data can be integrated with samples aggregated from various system sensors. When the vehicle 100 starts driving, state of charge estimation begins by analyzing voltage sag and the battery's ability to support current loads. Each sample taken may contribute to refining the range loss estimation during subsequent sleep intervals.

Environmental conditions may be represented by more conservative predetermined sleep state power consumption rate estimations, preconfigured as a worst-case estimation across varying climates. The subject technology provides for adaptation to local environmental conditions, providing region-specific adjustments to improve prediction accuracy for users in diverse environments. This adaptability to diverse climates may be beneficial to reduce discrepancies between estimated and actual range loss by factoring in both vehicle-specific configurations and user input, if available.

The subject technology also can provide for dynamic range loss estimation profiles based on vehicle configuration. For example, fleet management data can enable profile-specific estimates, such as higher power consumption profiles for vehicles equipped with additional devices (e.g., cameras, security systems) that draw power during sleep mode. Each vehicle configuration can be optimized for individual range loss, yielding range loss estimations aligned with specific operational features.

The vehicle 100 includes connected vehicle capabilities that may allow the vehicle 100 to store and transmit collected data to a central repository (not shown) over a network. This centralized system can aggregate fleet-wide data, enabling further refinement of predictive models. Fleet-based insights can be accessible to other vehicles including the vehicle 100, facilitating a universal dataset that enhances range loss estimations for vehicles within the same geographical region.

The initial range loss estimation may originate from cloud feed data. This cloud feed data can provide an updated range loss estimation, which may be transmitted to both the vehicle 100 and a cloud system (not shown). The cloud system may subsequently generate an updated remaining range estimation based on the updated range loss estimation, facilitating continuous synchronization between local and cloud-based range loss estimations.

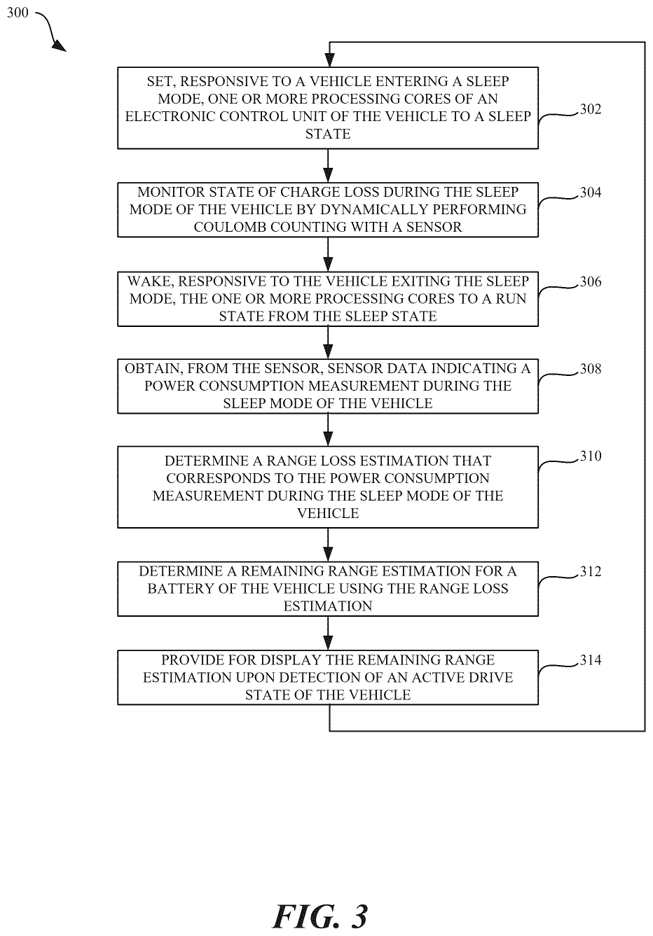

FIG. 3 illustrates a flow diagram of an example process for performing sensor-based sleep state consumption estimation for a vehicle, in accordance with implementations of the subject technology. For explanatory purposes, the process 300 is primarily described herein with reference to the vehicle 100, the sensor(s) 104, the processing circuitry 108 of FIGS. 1A-1B, and the ECU 210 of FIG. 2. However, the process 300 is not limited to the vehicle 100, the sensor(s) 104, and the processing circuitry 108 of FIGS. 1A-1B, and one or more blocks (or operations) of the process 300 may be performed by one or more other components of other suitable moveable apparatuses, devices, or systems. Further for explanatory purposes, some of the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

As illustrated in FIG. 3, at block 302, responsive to a vehicle (e.g., vehicle 100) entering a sleep mode, one or more processing cores of an electronic control unit (e.g., ECU 210) of the vehicle may be set to a sleep state.

At block 304, the state of charge loss during the sleep mode of the vehicle is monitored by dynamically performing coulomb counting with one or more sensors (e.g., sensor 104). When in sleep mode, the duration of this sleep state may not impact data collection, as the one or more processing cores directly read from the one or more sensors 104. The process 300 can provide for continuous monitoring during the sleep mode of the vehicle 100. The one or more sensors 104 can operate with a local power source, supplied by the secondary power converter 260, which also powers auxiliary systems such as the vehicle alarm during the sleep mode. A first coulomb count measurement may be obtained at a first location between the high voltage battery pack 220 and the vehicle power load 270 using a first sensor of a plurality of sensors. For example, the first sensor 104 may be located at an output of the secondary power converter 260. In another example, the first sensor 104 may be located an input of the secondary power converter 260. A second coulomb count measurement may be obtained at a second location between the low voltage battery pack 250 and the vehicle power load 270 using a second sensor of the plurality of sensors. For example, a second sensor 104 may be located at an output of the low voltage battery pack 250.

At block 306, responsive to the vehicle exiting the sleep mode, the one or more processing cores may wake to a run state from the sleep state. At every wake cycle, the one or more processing cores can collect sensor data on the consumed energy. This dynamic reading of the one or more sensors 104 can reflect the range loss during the sleep mode without requiring updates to baseline range loss values. The one or more processing cores can function by sampling the one or more sensors 104 directly each time, negating the need for recalibrating the baseline range loss values.

At block 308, the one or more processing cores may obtain sensor data indicating power consumption during the sleep mode of the vehicle from the one or more sensors. The one or more processing cores may read measurement values from the one or more sensors 104 each time the vehicle 100 transitions from sleep mode to an active state. For example, this process can begin with an initial estimate, after which the vehicle 100 enters sleep mode. Upon waking, the one or more processing cores may retrieve values from the one or more sensors 104 to update the range loss estimations. The updated range loss can then be calculated, utilizing a granular and accurate data set from the one or more sensors 104. When the vehicle 100 exits the sleep mode, and upon the user's entry and subsequent driving of the vehicle 100, the consumed range loss data can be extracted from the one or more sensors 104.

At block 310, the one or more processing cores may determine, based on sensor data from the one or more sensors, a range loss estimation that corresponds to the power consumption during the sleep mode of the vehicle. Once the vehicle 100 is in a wake state (or active state), a new range loss estimation can be computed based on the latest sensor data gathered from the one or more sensors 104.

At block 312, the one or more processing cores may determine a remaining range estimation for a battery (e.g., battery pack 110) of the vehicle using the range loss estimation. Prior to entering sleep mode, the vehicle 100 has an available range, and during the sleep mode, the one or more sensors 104 can measure the power consumption value. Upon exiting the sleep mode, the vehicle 100 can recalculate the actual remaining range based on the one or more sensors 104 reading.

At block 314, the one or more processing cores may provide for display the remaining range estimation upon detection of an active drive state of the vehicle. Also, at block 314, the one or more processing cores may return from the run state to the sleep state (e.g., at block 302) upon detecting the vehicle entering the sleep mode.

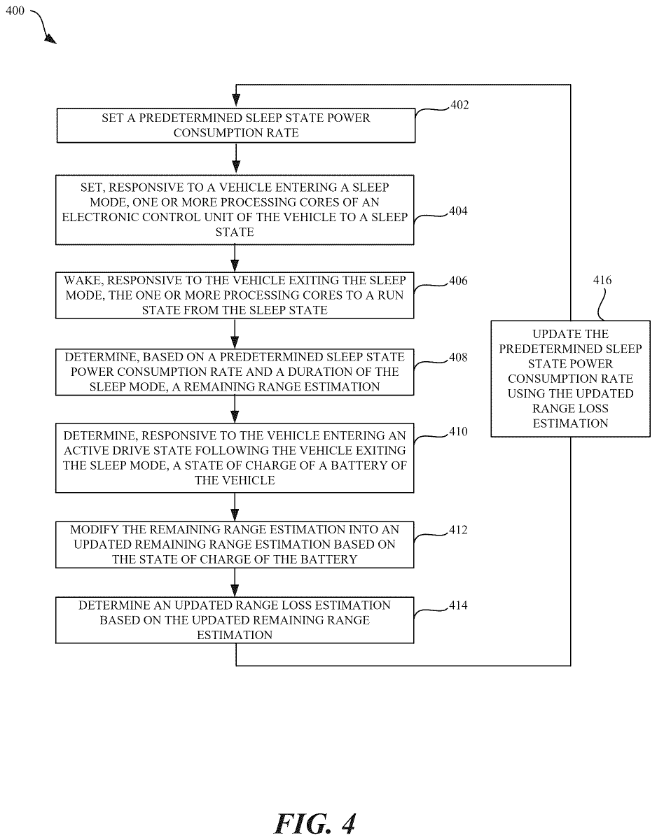

FIG. 4 illustrates a flow diagram of an example process for performing self-learning sleep state consumption estimation for a vehicle, in accordance with implementations of the subject technology. For explanatory purposes, the process 400 is primarily described herein with reference to the vehicle 100, the sensor(s) 104, the processing circuitry 108 of FIGS. 1A-1B, and the ECU 210 of FIG. 2. However, the process 400 is not limited to the vehicle 100, the sensor(s) 104, and the processing circuitry 108 of FIGS. 1A-1B, and one or more blocks (or operations) of the process 400 may be performed by one or more other components of other suitable moveable apparatuses, devices, or systems. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

As illustrated in FIG. 4, at block 402, a predetermined sleep state power consumption rate value may be set. The redetermined sleep state power consumption rate value may be in a range of 10 watts per hour to 30 watts per hour.

At block 404, responsive to a vehicle (e.g., vehicle 100) entering a sleep mode, one or more processing cores of an electronic control unit (e.g., ECU 210) of the vehicle 100 may be set to a sleep state. Upon entering sleep mode, the ECU 210 can apply the predetermined sleep state power consumption rate. At block 406, responsive to the vehicle 100 exiting the sleep mode, the one or more processing cores may wake to a run state from the sleep state.

At block 408, the one or more processing cores may determine a remaining range estimation for a battery (e.g., battery pack 110) of the vehicle 100 based on the predetermined sleep state power consumption rate value and a duration during which the vehicle 100 is in sleep mode. Upon exiting the sleep mode, the ECU 210 can calculate a total range loss during the sleep mode based on a sleep mode duration, computed as t_{wake}−t0, where t₀ is the time at which the vehicle 100 enters the sleep mode and t_{wake} is the time at which the vehicle 100 exits the sleep mode and enters a wake state. For example, when the vehicle 100 transitions from the sleep mode to the wake state, the ECU 210 can calculate a range loss estimation based on the sleep mode duration and the predetermined sleep state power consumption rate to provide a user of the vehicle 100 with a remaining range estimation.

At block 410, the one or more processing cores may determine, responsive to the vehicle entering an active drive state following the vehicle 100 exiting the sleep mode, a state of charge of the battery pack 110 of the vehicle 100. As driving resumes, the ECU 210 can recalibrate the state of charge of the high voltage battery pack 220 by updating the remaining range estimation based on real-time conditions and generating an updated range loss estimation.

At block 412, the one or more processing cores may modify the remaining range estimation into an updated remaining range estimation based on the state of charge of the battery pack 110. At block 414, the one or more processing cores may determine an updated range loss estimation based on the updated remaining range estimation.

At block 416, the one or more processing cores may update the predetermined sleep state power consumption rate value using the updated range loss estimation by way of a feedback mechanism. The feedback mechanism allows the vehicle 100 to track sleep mode duration, calculate a corresponding range loss during that duration, and update the baseline range loss estimation iteratively. During each key cycle, the vehicle 100 can recalculate its remaining range estimation based on newly gathered data, establishing an updated remaining range estimation for subsequent intervals. With each key cycle, the feedback mechanism can recalibrate, adapting the range loss estimations dynamically across variable usage patterns.

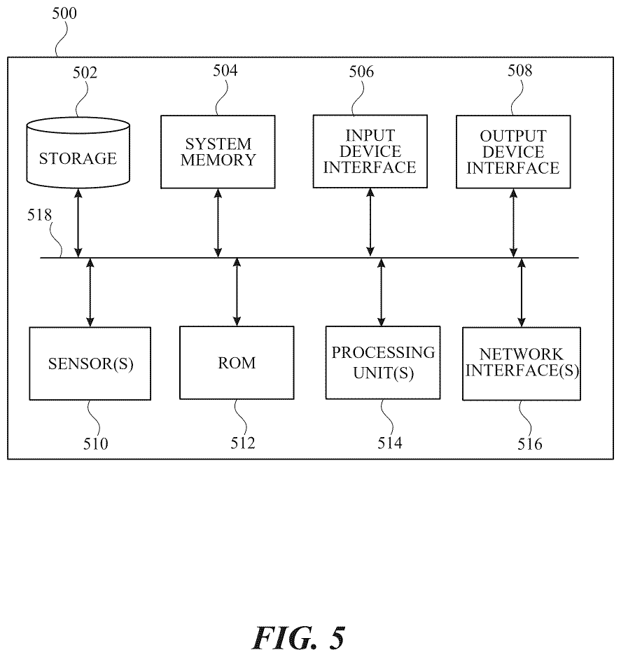

FIG. 5 illustrates an example electronic system 500 with which aspects of the present disclosure may be implemented. The electronic system 500 can be, and/or can be a part of, any electronic device for providing the features and performing processes described in reference to FIGS. 1A-4, including but not limited to a vehicle, computer, server, smartphone, and wearable device. The electronic system 500 may include various types of computer-readable media and interfaces for various other types of computer-readable media. The electronic system 500 includes a persistent storage device 502, system memory 504 (and/or buffer), input device interface 506, output device interface 508, sensor(s) 510, ROM 512, processing unit(s) 514, network interface 516, bus 518, and/or subsets and variations thereof.

The bus 518 collectively represents all system, peripheral, and chipset buses that communicatively connect the numerous internal devices and/or components of the electronic system 500, such as any of the components of the vehicle 100 discussed above with respect to FIG. 5. The bus 518 communicatively connects the one or more processing unit(s) 514 with the ROM 512, the system memory 504, and the persistent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations. In one or more implementations, one or more of the processing unit(s) 514 may include the processing circuitry 108.

The ROM 512 stores static data and instructions that are needed by the one or more processing unit(s) 514 and other modules of the electronic system 500. The persistent storage device 502, on the other hand, may be a read-and-write memory device. The persistent storage device 502 may be a non-volatile memory unit that stores instructions and data even when the electronic system 500 is off. In one or more implementations, a mass-storage device (such as a magnetic or optical disk and its corresponding disk drive) may be used as the persistent storage device 502.

In one or more implementations, a removable storage device (such as a flash drive and its corresponding solid-state device) may be used as the persistent storage device 502. Like the persistent storage device 502, the system memory 504 may be a read-and-write memory device. However, unlike the persistent storage device 502, the system memory 504 may be a volatile read-and-write memory, such as RAM. The system memory 504 may store any of the instructions and data that one or more processing unit(s) 514 may need at runtime. In one or more implementations, the processes of the subject disclosure are stored in the system memory 504, the persistent storage device 502, and/or the ROM 512. From these various memory units, the one or more processing unit(s) 514 retrieves instructions to execute and data to process in order to execute the processes of one or more implementations.

The persistent storage device 502 and/or the system memory 504 may include one or more machine learning models. Machine learning models, such as those described herein, are often used to form predictions, solve problems, recognize objects in image data, and the like. For example, machine learning models described herein may be used to predict the range loss during a sleep mode of a vehicle. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 518 also connects to the input device interfaces 506 and output device interfaces 508. The input device interface 506 enables a user to communicate information and select commands to the electronic system 500. Input devices that may be used with the input device interface 506 may include, for example, alphanumeric keyboards, touch screens, and pointing devices. The output device interface 508 may enable the electronic system 500 to communicate information to users. For example, the output device interface 508 may provide the display of images generated by electronic system 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 518 also connects to sensor(s) 510. In one or more implementations, the sensor(s) 510 include the sensor 104. The sensor(s) 510 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). The sensor(s) 510 may be utilized to detect movement, travel, and orientation of the electronic system 500. For example, the sensor(s) may include an accelerometer, a rate gyroscope, and/or other motion-based sensor(s).

The bus 518 also couples the electronic system 500 to one or more networks and/or to one or more network nodes through the one or more network interface(s) 516. In this manner, the electronic system 500 can be a part of a network of computers (such as a local area network or a wide area network). Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. The tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An electronic control unit for a vehicle, the electronic control unit comprising:
one or more processing cores; and
wherein the one or more processing cores are configured to:
enter a sleep state responsive to the vehicle entering a sleep mode,
enter a run state from the sleep state responsive to the vehicle exiting the sleep mode; and
determine, based on a range loss estimation corresponding to an estimated power consumption during the sleep mode, a remaining range estimation of the vehicle.

2. The electronic control unit of claim 1, wherein the one or more processing cores are configured to:
obtain, from one or more sensors of the vehicle, sensor data indicating a power consumption measurement during the sleep mode of the vehicle; and
determine, based on the sensor data, the range loss estimation that corresponds to the power consumption measurement.

3. The electronic control unit of claim 2, wherein the one or more processing cores are configured to, responsive to determining the range loss estimation, provide the remaining range estimation of the vehicle to a device of a user.

4. The electronic control unit of claim 2, wherein the one or more sensors comprises a power sensor.

5. The electronic control unit of claim 1, wherein the one or more processing cores are configured to provide for display the remaining range estimation upon detection of an active drive state of the vehicle.

6. The electronic control unit of claim 1, wherein the one or more processing cores are further configured to:
obtain a first coulomb count measurement at a first location between a high voltage battery pack and a vehicle power load using a first sensor of a plurality of sensors; and
obtain a second coulomb count measurement at a second location between a low voltage battery pack and the vehicle power load using a second sensor of the plurality of sensors,
wherein the range loss estimation is determined using the first coulomb count measurement and the second coulomb count measurement.

7. The electronic control unit of claim 6, wherein the one or more processing cores configured to obtain the first coulomb count measurement are further configured to obtain sensor data from the first sensor located at an output of a secondary power converter connected to an output of the high voltage battery pack.

8. The electronic control unit of claim 6, wherein the one or more processing cores configured to obtain the first coulomb count measurement are further configured to obtain sensor data from the first sensor located at an input to a secondary power converter connected to an output of the high voltage battery pack.

9. The electronic control unit of claim 1, wherein the remaining range estimation is determined based on a predetermined sleep state power consumption rate and a duration of the sleep mode, wherein the one or more processing cores are configured to:
determine, responsive to the vehicle entering an active drive state following the vehicle exiting the sleep mode, a state of charge of a battery of the vehicle;
modify the remaining range estimation into an updated remaining range estimation based on the state of charge of the battery; and
provide for display the updated remaining range estimation.

10. The electronic control unit of claim 9, wherein the one or more processing cores are configured to determine an updated range loss estimation based on the updated remaining range estimation.

11. The electronic control unit of claim 10, wherein the one or more processing cores are configured to update the predetermined sleep state power consumption rate using the updated range loss estimation.

12. The electronic control unit of claim 11, wherein the predetermined sleep state power consumption rate is iteratively updated after each update to the range loss estimation.

13. A method, comprising:
setting, responsive to a vehicle entering a sleep mode, one or more processing cores of an electronic control unit of the vehicle to a sleep state;
performing coulomb counting using one or more sensors to monitor a state of charge loss during the sleep mode of the vehicle;
waking, responsive to a vehicle exiting the sleep mode, the one or more processing cores to a run state from the sleep state; and
determining, by the one or more processing cores and based on the coulomb counting, a range loss estimation that corresponds to the state of charge loss during the sleep mode of the vehicle.

14. The method of claim 13, further comprising:
obtaining, from the one or more sensors, sensor data indicating a power consumption measurement during the sleep mode of the vehicle, wherein the range loss estimation corresponds to the power consumption measurement.

15. The method of claim 13, further comprising:
determining, by the one or more processing cores and based on the range loss estimation, a remaining range estimation; and
providing for display the remaining range estimation upon detection of an active drive state of the vehicle.

16. The method of claim 13, wherein performing the coulomb counting comprises:
obtaining a first coulomb count measurement at a first location between a high voltage battery pack and a vehicle power load using a first sensor of a plurality of sensors; and
obtaining a second coulomb count measurement at a second location between a low voltage battery pack and the vehicle power load using a second sensor of the plurality of sensors,
wherein the range loss estimation is determined using the first coulomb count measurement and the second coulomb count measurement.

17. The method of claim 16, wherein obtaining the first coulomb count measurement comprises obtaining sensor data from the first sensor located at an output of a secondary power converter connected to an output of the high voltage battery pack.

18. The method of claim 16, wherein obtaining the first coulomb count measurement comprises obtaining sensor data from the first sensor located at an input to a secondary power converter connected to an output of the high voltage battery pack.

19. An electric vehicle, comprising:
an electronic control unit comprising:
one or more processing cores; and
wherein the one or more processing cores are configured to:
enter a sleep state responsive to the electric vehicle entering a sleep mode;
enter a run state from the sleep state responsive to the electric vehicle exiting the sleep mode;
determine, based on a predetermined sleep state power consumption rate and a duration of the sleep mode, a remaining range estimation;
determine, responsive to the electric vehicle entering an active drive state following the electric vehicle exiting the sleep mode, a state of charge of a battery of the electric vehicle;
modify the remaining range estimation into an updated remaining range estimation based on the state of charge of the battery; and
provide for display the updated remaining range estimation.

20. The electric vehicle of claim 19, wherein the one or more processing cores are further configured to:
modify a range loss estimation into an updated range loss estimation based on the updated remaining range estimation; and
update the predetermined sleep state power consumption rate using the updated range loss estimation,
wherein the predetermined sleep state power consumption rate is iteratively updated after each update to the range loss estimation.
